(19) United States
(12) Patent Application Publication
(10) Pub. No.: US 2006/0041767 A1
(43) Pub. Date: Feb. 23, 2006

(54) Methods, devices and computer program products for controlling power supplied to devices coupled to an uninterruptible power supply (UPS)

(76) Inventors: Marcus A. Maxwell, Wake Forest, NC (US); Dennis Cummins, Raleigh, NC (US)

Correspondence Address: Elizabeth A. Stanek;Myers Bigel Sibley & Sajovec, Post Office Box 37428, Raleigh, NC, 27627, US

(21) Appl. No.: 10/922,775

(22) Filed: Aug. 20, 2004

(51) Int. Cl. G06F 1/30

(52) U.S. Cl. 713/323

(57) ABSTRACT

Methods, devices, systems and computer program products for operating a networked device coupled to an uninterruptible power supply (UPS) are provided. One or more networked devices are programmed with priority information. The one or more networked devices are further programmed to enter a reduced power state based on the priority information following receipt of a power interruption indication signal from the UPS. The power interruption indication signal indicates that power from a primary source of power has been interrupted.

### BACKGROUND OF THE INVENTION

The present invention relates to power supply apparatus and methods of operation thereof, and more particularly, to uninterruptible power supplies (UPSs) and methods of operation thereof.

UPSs are commonly used to provide conditioned and/or auxiliary power to electronic equipment that provides critical functions, such as computer systems, telecommunications systems and medical equipment. Typically, UPSs can provide AC power from a backup source, such as a battery, generator or fuel cell, in the event that a utility power supply fails or becomes degraded.

A single UPS may be used to provide backup power to a large number of devices, for example, servers, monitors, coffee makers, refrigerators and the like. When the utility power is lost or becomes degraded, the UPS may provide power to all of these devices from the backup source. Conventional UPSs may include one or more load segments, i.e., groups of receptacles that can be independently controlled. Typically power can only be removed from devices being power by the UPS by turning off the UPS or by removing power from all of the devices plugged into a load segment. Methods and devices for removing power provided by a UPS from one or more devices are discussed in U.S. Pat. No. 4,611,289 to Coppola entitled Computer Power Management System and U.S. Pat. No. 5,534,734 to Pugh et al. entitled Power Shedding Device.

In particular, Coppola discusses a central microprocessor that sends shutdown data signals to “critical task” and “non-critical task” computers. Cessation of program execution and data saving occurs promptly upon assertion of a “shutdown data” signal. In particular, the non-critical task computers cease program execution and store data upon power failure conditions. The critical task computers cease normal program execution and save data promptly to prevent battery power from running out before the data is saved. Therefore, for both types of computers, the shutdown data signals generated are generated by the microprocessor. Thus, the microprocessor is programmed with all the information about each of the devices, both critical and non-critical. It is important that this information be accurate and up to date. Each time a computer, server, router or the like is added to the network, the information stored at the microprocessor has to be updated. Accordingly, this could become very cumbersome for a system administrator.

Furthermore, to conserve the amount of power used from the backup power source, devices, such as computers or servers, may be placed in a standby mode during a power loss. For example, operating systems running on servers may enter a reduced power state, but some power will still be supplied to the servers from the backup source. Thus, the devices in standby mode may still be drawing some power from the backup source. Furthermore, once the primary power source is restored, each of the devices placed in standby mode may have to be awakened manually before service can be fully restored. This can be quite time consuming if the UPS is used to provide power to an entire office building including hundreds of servers, all of which were put in standby mode during the power loss.

### SUMMARY OF THE INVENTION

Some embodiments of the present invention provide methods, devices and computer program products for operating a networked device coupled to an uninterruptible power supply (UPS). One or more networked devices are programmed with priority information. The one or more networked devices are further programmed to enter a reduced power state based on the priority information following receipt of a power interruption indication signal from the UPS. The power interruption indication signal indicates that power from a primary source of power has been interrupted.

In further embodiments of the present invention, the power interruption indication signal may be received at the one or more programmed networked devices and the reduced power state may be entered at the one or more programmed networked devices based on the priority information responsive to the received power interruption indication signal.

In still further embodiments of the present invention, a timer may be set at the one or more programmed networked devices based on the priority information responsive to the received power interruption indication signal. The reduced power state may be entered at the one or more programmed networked devices upon expiration of the timer.

In some embodiments of the present invention, an alert signal may be sounded at the one or more programmed networked devices responsive to the received power interruption indication signal so as to provide notification that the one or more programmed networked devices will enter a reduced power state.

In further embodiments of the present invention, a power restoration indication signal may be received from the UPS at the one or more programmed networked devices indicating that power from the primary source of power has been restored. A power up process may be initiated at the one or more programmed networked devices based on the priority information responsive to the power restoration indication signal.

In still further embodiments of the present invention, a timer may be set at the one or more programmed networked devices based on the priority information responsive to the received power restoration indication signal. The power up process may be initiated at the one or more programmed networked devices upon expiration of the timer.

In some embodiments of the present invention, an alert signal may be sounded at the one or more programmed networked devices responsive to the received power restoration indication signal so as to provide notification that the one or more programmed networked devices will be powered up.

Further embodiments of the present invention provide methods and systems for operating devices. A first device is pre-configured to enter a reduced power state at a first time following receipt of a power interruption indication signal. The first device has a first associated importance level and is coupled to a backup power source through a power distribution device. A second device is pre-configured to enter the reduced power state at a second time, greater than the first time, following receipt of the power interruption indication signal. The second device has a second associated importance level, greater than the first importance level, and is coupled to the backup power source through the power distribution device. The power interruption indication signal is transmitted from the power distribution device indicating that power from a primary source of power has been interrupted. The power interruption indication signal is received from the power distribution device at the first and second devices and the reduced power state is entered at the first device at the first time and at the second device at the second time responsive to the received power interruption indication signal.

In still further embodiments of the present invention, a first timer may be set at the first device to the first time and a second timer may be set at the second device to the second time responsive to the received power interruption indication signal. The reduced power state may be entered at the first device upon expiration of the first timer and may be entered at the second device upon expiration of the second timer.

In some embodiments of the present invention, a first group of devices may be pre-configured having the first importance level a second group of devices may be pre-configured having the second importance level. A first timer may be set at the first group of devices to the first time and a second timer may be set at the second group of devices to the second time responsive to the received power interruption indication signal. The reduced power state may be entered at the first group of devices upon expiration of the first timer and at the second group of devices upon expiration of the second timer.

In further embodiments of the present invention, an alert signal may be sounded at the first and/or second devices responsive to the received power interruption indication signal so as to provide notification that power at the first and/or second devices will be reduced.

In still further embodiments of the present invention, a power restoration indication signal may be transmitted to the first and/or second devices indicating that power from a primary source of power has been restored. The power restoration indication signal may be received at the first and/or second devices. A power up process may be initiated at the first and/or second devices responsive to the received power restoration indication signal.

In some embodiments of the present invention, a first timer may be set at the first device to a third time and a second timer may be set at the second device to a fourth time responsive to the received power restoration indication signal. The power up process may be initiated at the first device upon expiration of the first timer and the power up process may be initiated at the second device upon expiration of the second timer.

In further embodiments of the present invention, an alert signal may be sounded at the first device and/or the second device responsive to the received power restoration indication signal so as to provide notification that the first and/or second devices will be powered up.

Although embodiments of the present invention are discussed above primarily with respect to methods, devices, systems and computer program products are also provided.

### BRIEF DESCRIPTION OF THE DRAWINGS

FIG. 1 is a block diagram of a data processing system of devices operating in accordance with some embodiments of the present invention.

FIG. 2 is a block diagram illustrating an exemplary environment for operations and apparatus according to some embodiments of the present invention.

FIG. 3 is a flowchart illustrating exemplary operations for designating devices to receive power from a backup power source according to some embodiments of the present invention.

FIG. 4 is a flowchart illustrating exemplary operations for operating devices according to further embodiments of the present invention.

### DETAILED DESCRIPTION OF EMBODIMENTS OF THE INVENTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements throughout. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention may be embodied as a method, system, device, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described in part below with reference to flow chart illustrations and/or block diagrams of methods, devices and computer program products according to embodiments of the invention. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flow chart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flow chart and/or block diagram block or blocks.

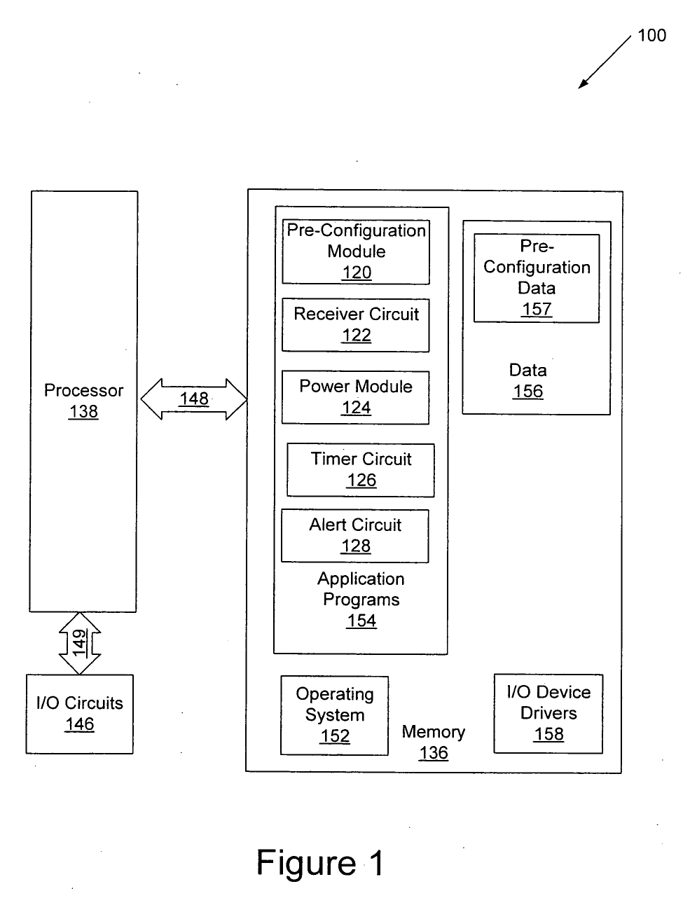

Exemplary embodiments of the present invention will now be described with respect to FIGS. 1 through 4. As discussed herein, some embodiments of the present invention provide methods, systems, devices and computer program products for managing power distribution of a backup power source. In some embodiments of the present invention, certain devices may be designated to enter a reduced power state when the primary power source is interrupted or lost. In other words, certain devices may not be provided a normal amount of power from a backup power source when the primary power source is unavailable. In some embodiments of the present invention, the designated or pre-configured devices may not all be in a single load segment, i.e., a physical group of receptacles, on the uninterruptible power supply (UPS) and individual devices within the load segment may be selected without selecting all of the devices plugged into the load segment. In certain embodiments of the present invention, different groups of devices (“virtual load segments”) may be designated as having different importance levels. The different groups of devices may be configured to draw power from the backup source of power for a predetermined period of time based on the associated importance level. Accordingly, designating certain devices to enter a reduced power state when a primary power source is unavailable may allow power to be provided to the more critical devices for a longer period of time. Thus, some embodiments of the present invention may enable the provision of power to the more critical devices from the backup power source until the primary power source is restored as discussed further herein.

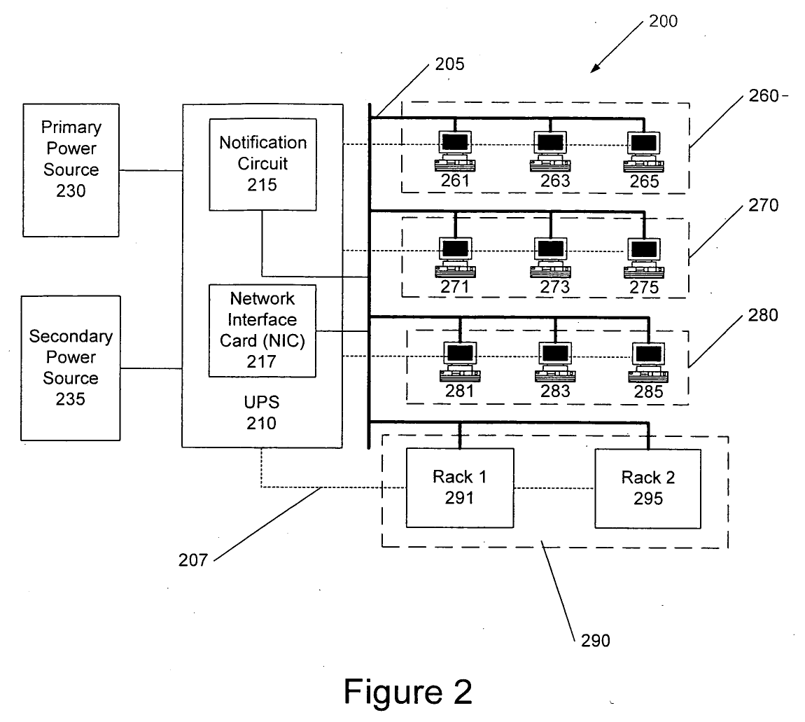

FIG. 1 illustrates an exemplary data processing system 100 that may be included in devices operating in accordance with some embodiments of the present invention. As illustrated, the data processing system 100 includes a processor 138, a memory 136 and input/output circuits 146. The data processing system 100 may be incorporated in, for example, a personal computer, server, router or the like as discussed further with respect to FIG. 2. The processor 138 communicates with the memory 136 via an address/data bus 148 and communicates with the input/output circuits 146 via an address/data bus 149. The input/output circuits 146 can be used to transfer information between the memory 136 and another computer system or a network using, for example, an Internet protocol (IP) connection. These components may be conventional components such as those used in many conventional data processing systems, which may be configured to operate as described herein.

In particular, the processor 138 can be any commercially available or custom microprocessor, microcontroller, digital signal processor or the like. The memory 136 may include any memory devices containing the software and data used to implement the functionality circuits or modules used in accordance with embodiments of the present invention. The memory 136 can include, but is not limited to, the following types of devices: cache, ROM, PROM, EPROM, EEPROM, flash memory, SRAM, DRAM and magnetic disk.

As further illustrated in FIG. 1, the memory 136 may include several categories of software and data used in the data processing system 100: an operating system 152; application programs 154; input/output device drivers 158; and data 156. As will be appreciated by those of skill in the art, the operating system 152 may be any operating system suitable for use with a data processing system, such as OS/2, AlX or zOS from International Business Machines Corporation, Armonk, N.Y., Windows95, Windows98, Windows2000 or WindowsXP from Microsoft Corporation, Redmond, Wash., Unix or Linux. The input/output device drivers 158 typically include software routines accessed through the operating system 152 by the application programs 154 to communicate with devices such as the input/output circuits 146 and certain memory 136 components. The application programs 154 are illustrative of the programs that implement the various features of the circuits and modules according to some embodiments of the present invention. Finally, the data 156 represents the static and dynamic data used by the application programs 154, the operating system 152, the input/output device drivers 158, and other software programs that may reside in the memory 136. As illustrated in FIG. 1, the data 156 may include pre-configuration data 157 for use by the circuits and modules of the application programs 154 according to some embodiments of the present invention as discussed further herein.

As further illustrated in FIG. 1, according to some embodiments of the present invention the application programs 154 include a pre-configuration module 120, a receiver circuit 122, a power module 124, a timer circuit 126, and an alert circuit 128. The pre-configuration module 120 may be configured to pre-configure one or more devices coupled to a power distribution device, for example, a UPS, to enter a reduced power state if power from a primary source of power is interrupted and/or to initiate a power up process from the reduced power state if power from the primary source of power is restored. In some embodiments of the present invention, the pre-configuration module 120 may be configured to program the one or more devices with priority information. As used herein, “priority information” refers to information related to the order in which devices should enter the reduced power state. As discussed further below, the priority information may be based on an importance level associated with the device. As further used herein, a “pre-configured device” refers to any device that may be coupled to a power distribution device, including servers, routers, hubs, telephones, printers and the like, that may be configured not to receive power from a backup power source during some or all of a time when power from the primary source of power is unavailable. In some embodiments of the present invention, the pre-configured devices may include the non-critical devices that may not be damaged or missed if power to these devices were reduced during a power loss.

The receiver circuit 122 may be configured to receive a power interruption indication signal from the power distribution device indicating that the primary source of power has been interrupted and/or a power restoration indication signal from the power distribution device indicating that power from the primary source of power has been restored. The power module 124 may be configured to enter the reduced power state at the one or more pre-configured devices responsive to the received power interruption indication signal and/or initiate a power up process at the pre-configured device responsive to the received power restoration indication signal. As used herein, “power up process” refers to restoring power to a device(s) that has been placed in a reduced power state.

In some embodiments of the present invention, the timer circuit 126 may be configured to set a timer at the one or more pre-configured devices responsive to the received power interruption indication signal and/or the power restoration indication signal. In embodiments of the present invention including the timer circuit 126, the power module 124 may be further configured to enter the reduced power state and/or initiate the power up process at the one or more pre-configured devices upon expiration of the timer. The alert circuit 128 may be configured to sound an alert signal responsive to the received power interruption indication signal and/or the power restoration indication signal so as to provide a notification that one or more of the pre-configured devices is about to have its power reduced and/or be powered up, respectively.

While the present invention is illustrated with reference to the pre-configuration module 120, the receiver circuit 122, the power module 124, the timer circuit 126, and the alert circuit 128 being application programs in FIG. 1, as will be appreciated by those of skill in the art, other configurations fall within the scope of the present invention. For example, rather than being application programs 154, these circuits and modules may also be incorporated into the operating system 152 or other such logical division of the data processing system 100. Furthermore, while the pre-configuration module 120, the receiver circuit 122, the power module 124, the timer circuit 126, and the alert circuit 128 are illustrated in a single data processing system, as will be appreciated by those of skill in the art, such functionality may be distributed across one or more data processing systems. Thus, the present invention should not be construed as limited to the configuration illustrated in FIG. 1, but may be provided by other arrangements and/or divisions of functions between data processing systems.

It will be further understood that embodiments of the present invention illustrated in FIG. 1 are provided for exemplary purposes only and that embodiments of the present invention are not limited to the configurations illustrated therein. For example, although FIG. 1 is illustrated as having various circuits and modules, one or more of these circuits or modules may be combined without departing from the scope of the present invention.

FIG. 2 illustrates an exemplary environment 200 for apparatus and operations according to some embodiments of the present invention. As illustrated in FIG. 2, the environment 200 may include a primary power source 230, a secondary power source 235, a UPS 210, and one or more devices 261, 263, 265, 271, 273, 275, 281, 283, 285, 291 and 295 according to some embodiments of the present invention. It will be understood that any of the devices 261, 263, 265, 271, 273, 275, 281, 283, 285, 291 and 295 illustrated in FIG. 2 may include the data processing system 100 discussed above with respect to FIG. 1.

As illustrated in FIG. 2, the UPS 210 may be provided to selectively couple primary and secondary power sources 230 and 235 to the one or more devices 261, 263, 265, 271, 273, 275, 281, 283, 285, 291 and 295. The primary power source 230 may be, for example, a commercial utility, and the secondary power source 235 may be, for example, a battery, generator, fuel cell or the like. The secondary power source 235 may be integrated with the UPS 210 and/or physically separate from the UPS 210. As illustrated, the UPS 210 may provide both power 207 and network 205 connections to the devices 261, 263, 265, 271, 273, 275, 281, 283, 285, 291 and 295. In some embodiments of the present invention, the UPS 210 may be, for example, a 3-phase UPS.

The UPS 210 may include a network interface card (NIC) 217, module or other circuit assembly configured to be installed in the UPS 210. For example, the UPS 210 may include a network card similar to a ConnectUPS Web/SNMP Card offered by Powerware Corporation of Delaware, the assignee of the present application. The ConnectUPS Web/SNMP Card is configured to install in a UPS to provide simple network management protocol (SNMP), hypertext transfer protocol (HTTP), simple mail transfer protocol (SMTP), wireless application protocol (WAP) and Telnet compatibility and advanced RS-232 communications. The network card may allow monitoring, management and safe shut down or re-boot of UPS-protected devices, for example, servers, routers, hubs and other key inter-networking devices in a controlled manner as discussed herein. ConnectUPS Web/SNMP cards may provide a link between the UPS 210 and, for example, an Ethernet local area/wide area network (LAN/WAN) running on the devices 261, 263, 265, 271, 273, 275, 281, 283, 285, 291 and 295, allowing the UPS 210 to notify the devices 261, 263, 265, 271, 273, 275, 281, 283, 285, 291 and 295 of the status of power.

As shown, the UPS 210 further includes a notification circuit 215 configured to transmit a power interruption indication signal to one or more of the devices 261, 263, 265, 271, 273, 275, 281, 283, 285, 291 and 295 indicating an interruption or loss of power provided by the primary power source 230. For example, the power interruption indication signal may indicate that the UPS 210 is “on battery” or “on bypass.” In some embodiments of the present invention, the notification circuit 215 may be further configured to transmit a power restoration indication signal to one or more of the devices 261, 263, 265, 271, 273, 275, 281, 283, 285, 291 and 295 indicating that power provided by the primary power source 230 has been restored and is now available. For example, the power restoration indication signal may indicate that “UPS on battery resolved” or “UPS on bypass resolved.”

As discussed above, one or more of the devices 261, 263, 265, 271, 273, 275, 281, 283, 285, 291 and 295 may be programmed with priority information and may be pre-configured to enter a reduced power state based on the priority information responsive to the power interruption indication signal indicating an interruption or loss of power and/or to initiate a power up process based on the priority information responsive to the power restoration indication signal indicating a restoration of power. For example, devices 261, 271, and 281 may be pre-configured to enter a reduced power state in the event that power provided by the primary power source 230 is lost or interrupted. Thus, according to some embodiments of the present invention, a user can pre-configure one or more devices, typically non-critical devices, to not receive backup power support from the secondary power source 235 for some or all of the time that power from the primary power source 230 is lost, so that power may be maintained at the most critical devices, devices 263, 265, 273, 275, 283, 285, 291 and 295 in this example, for a longer period of time. It will be understood that the pre-configured devices, devices 261, 271 and 281 in this example, can be included in separate physical load segments and that power may be removed from these devices 261, 271, 281 and still be provided to other devices in their corresponding physical load segments.

In some embodiments of the present invention, the devices may be pre-configured by installing software that enables functionalities according to some embodiments of the present invention on the individual devices during configuration of the device. For example, some embodiments of the present invention may use Microsoft Windows Operating Systems Power Management capabilities from Microsoft Corporation, Redmond, Wash. The power management software may provide a user interface, for example, a graphical user interface (GUI), during setup of the device and installation of the software that allows an installer to pre-configure the device to enter a reduced power state in the event of a power loss and/or to be powered up when power is restored. For example, the GUI may provide the following options: “allow this device to bring the computer out of standby” or “allow the computer to turn off this device to save power.” These options are provided for exemplary purposes only and embodiments of the present invention should not be limited to these examples. Any equivalent feature as defined by, for example, ACPI may be used without departing from the scope of the present invention. For example, a wake on LAN (WOL) ACPI command may be used to awake a pre-configured device(s) when power is restored.

The installer of the software may select one or both of these options. Each of these options may be associated with UPS power event conditions. For example, the option that allows the device to bring the computer out of standby may be selected for when the UPS is coming off battery and/or when the UPS is coming off bypass. For example, the device may be awakened after power is restored responsive to network card activity or a modem ring. Similarly, the option that allows the computer to turn off the device to save power may be selected for when the UPS is on battery and/or when the UPS is on bypass.

In some embodiments of the present invention, a monitor or group of monitors may be configured during installation to initiate a power down process when the UPS is on battery and/or bypass. For example, the installer may use an ACPI command to configure the monitors to power off if the UPS is on battery or bypass. These monitors may be, for example, monitors coupled to servers running in an IT data center that may not be assigned to a user. Thus, the servers may operate without a monitor. Shutting down the monitors associated with the servers may conserve enough power in the backup power source to possibly provide power to the critical systems until the primary power is restored.

In some embodiments of the present invention, the pre-configured device or devices may be powered off using operation system standby and/or hibernation features known to those having skill in the art. Some embodiments of the present invention use ATX compliant AC power supplies and motherboards and comply with the advanced configuration and power interface (ACPI) standard for controlling power and computer systems. The ACPI specification offers various options to directly control AC power of a computer, as well as power to certain peripheral devices. These capabilities may enable UPS power management software to take advantage of these functions as discussed herein.

Referring again to FIG. 2, in some embodiments of the present invention, different groups 260, 270, 280 and 290 of devices may be created during installation. Each of the groups 260, 270, 280 and 290 may have an associated importance level, for example, a low importance level, a medium importance level and a high importance level. In other words, in some embodiments of the present invention, the devices may be programmed with priority information and preconfigured based on the priority information such that different groups 260, 270, 280 and 290 may enter a reduced power state at different times based on the importance level associated therewith. As discussed above, the priority information may reflect the importance level associated with a particular device. For example, a first group of devices 260 may include unoccupied user terminals, which may be assigned a very low importance level. A second group of devices 270 may include servers used to run very important test simulations, thus, having a higher importance level relative to the unoccupied user terminals. The first group of devices 260 may be pre-configured to enter a reduced power state before the second group of devices 270.

The pre-configured groups may be designated during setup and configuration of the devices making up the groups. Thus, the options on the user interface may be more detailed than those discussed above. For example, an option may allow the computer to turn off the device to save power after the UPS has been on bypass for 30 minutes. The time limit set may be set based on the importance level associated with the group of devices. Furthermore, when powering up the devices when power is restored, the groups of devices 260, 270, 280 and 290 may be powered up at different times, i.e., the groups with the highest importance level may be powered up first. For example, an option may be “allow this device to bring the computer out of standby 20 minutes after power is restored.”

It will be understood that the configured device or groups of devices may also be powered up manually. Furthermore, a display may be provided at the UPS 210 including an icon for each of the devices 261, 263, 265, 271, 273, 275, 281, 283, 285, 291 and 295 in the environment 200. A user may click on the icon associated with the device to which power is to be provided. A power signal may be sent to any of the devices 261, 263, 265, 271, 273, 275, 281, 283, 285, 291 and 295 and the power module 122 may power on the device responsive to the power signal. Thus, it may also be possible to manually power on the devices from a remote location.

As discussed above, some devices according to embodiments of the present invention may include a timer circuit 126 (FIG. 1). Thus, for example, when a power interruption indication signal indicating detection of the loss of power from the primary power source 230 is received from the notification circuit 215 of the UPS 210 at the receiver circuit 122 of a first device 261 and a second device 271, a first timer circuit 126 may be set with respect to the first device 261 and a second timer circuit 126 may be set with respect to the second device 271. Accordingly, the first device 261 may be configured to enter a reduced power state when the first timer expires and the second device 271 may be configured to enter a reduced power state when the second timer expires. The timer circuit 126 may be also be set when the device receives a power restoration indication signal indicating that power from the primary power source 230 has been restored. A power on process may be initiated by the power module 124 of the device when the timer expires.

As further discussed above, some devices according to embodiments of the present invention may include an alert circuit 128. The alert circuit 128 may be configured to sound an alert signal at the device, remote from the UPS 210, before the device enters a reduced power state and/or is powered up. In particular embodiments of the present invention, the alert circuit 128 may be configured to sound an alert signal at a pre-configured device responsive to the power interruption indication signal from the UPS 210 indicating that the UPS 210 is on battery or bypass, i.e., the primary source of power has been lost or interrupted, or the power restoration indication signal indicating that the UPS 210 has come off battery or bypass, i.e., the primary source of power has been restored. Thus, the alert circuit 128 may be capable of communicating with the UPS 210 even when the device is in a reduced power state or in a zero power state. Accordingly, a user or technician at a pre-configured device, remote from the UPS 210, may have the opportunity to thwart the reduction of power of the pre-configured device. Furthermore, an alert signal indicating application or imminent application of power, may provide a technician working on the pre-configured device the opportunity to removed himself and any objects from the device so as not to be shocked and/or the opportunity to manually thwart the powering on of the device.

It will be understood that in some embodiments of the present invention, the alert circuit 128 may be powered by the UPS 210. The alert circuit 128 produces an alert signal having a safe, low-voltage signal and is provided enough power to activate the alert circuit 128. Thus, as discussed above, in some embodiments of the present invention, the alert signal can be activated even when the UPS 210 is not providing any AC power to the device, i.e., a true zero power state.

It will be further understood that although the alert circuit 128 is illustrated as being part of the data processing system 100 (FIG. 1) of a device according to embodiments of the present invention, embodiments of the alert circuit 128 are not limited to this configuration. For example, the alert circuit 128 may be separate from the device, but still coupled to the UPS 210 so as to allow the alert circuit 128 to receive the power interruption indication signal and/or the power restoration indication signal from the notification circuit 215 of the UPS 210. It will be further understood that the alert circuit 124 may be associated with one or more devices in physical or virtual load groups without departing from the scope of the present invention.

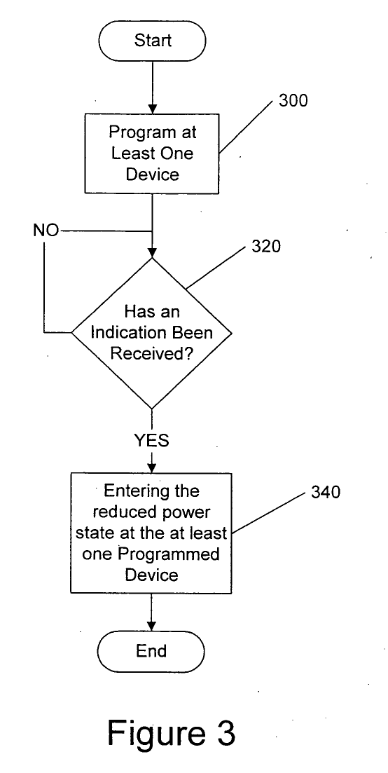

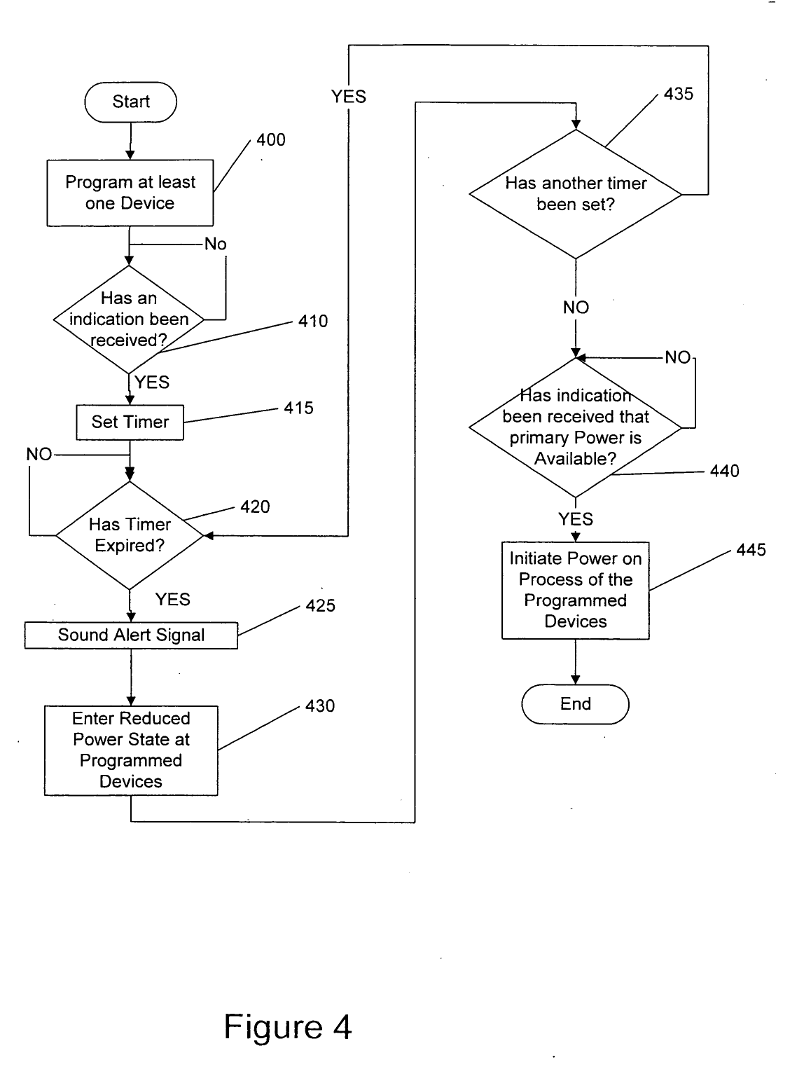

Operations for operating devices according to some embodiments of the present invention will now be discussed with respect to FIGS. 3 and 4. Operations begin at block 300 by programming one or more devices with priority information and pre-configuring the one or more devices to enter a reduced power state based on the priority information following receipt of a power interruption indication signal. For example, in some embodiments of the present invention, the devices may be pre-configured during configuration of the device using Microsoft Windows Operating Systems Power Management capabilities from Microsoft Corporation, Redmond, Wash. The power management software may provide a user interface, for example, a graphical user interface (GUI), during setup of the device and installation of the software that allows an installer to pre-select the device to enter a reduced power state in the event of a power loss and/or to be powered up when power is restored as discussed above. It is determined if a power interruption indication signal has been received at the pre-configured device or devices indicating that the primary source of power has been interrupted (block 320). If the power interruption indication signal has not been received (block 320), operations remain at block 320 until the power interruption indication signal is received. If the power interruption indication is received (block 320), the pre-configured device or devices may enter a reduced power state responsive to the received power interruption indication signal (block 340).

Operations according to further embodiments of the present invention will now be discussed with respect to FIG. 4. Operations begin at block 400 by programming one or more devices with priority information and pre-configuring the one or more devices to enter a reduced power state based on the priority information following receipt of a power interruption indication signal. It is determined if a power interruption indication signal has been received at the device or devices indicating that the primary source of power has been interrupted (block 410). If the power interruption indication signal has not been received (block 410), operations remain at block 410 until the power interruption indication signal is received. If the power interruption indication signal is received (block 410), a timer may be set at one or more of the devices (block 415). It is determined if the timer has expired (block 420). If it is determined that the timer has not expired (block 420), operations remain at block 420 until the timer expires. If it is determined that the timer has expired (block 420), an alert signal may be sounded to indicate that the pre-configured device will enter a reduced power state (block 425). The device may enter a reduced power state (block 430).

It is determined if another timer has been set (block 435). If another timer has been set (block 430), operations return to block 420 and repeat until it is determined that no more timers have been set. If another timer has not been set (block 435), it is determined if a power restoration indication signal has been received indicating that the primary source of power is available (block 440). If the power restoration indication signal has been received (block 440), the device may initiate a power on process. It will be understood that in some embodiments of the present invention an alert signal may be sounded before the device is powered up. If the power restoration indication signal has not been received (block 440), operations remain at block 440 until an indication is received.

As discussed above with respect to FIGS. 1 through 4, the individual network devices themselves are programmed with priority information and pre-configured to enter a reduced power state based on the priority information upon receipt of a power interruption indication signal from a UPS. Thus, in contrast to prior art power reduction devices, embodiments of the present invention do not need a central microprocessor that includes information related to each and every device on the network. Devices according to embodiments of the present invention are each individually programmed with the information needed to enter a reduced power state responsive to receipt of a power interruption indication signal from the UPS. Thus, embodiments of the present invention may enable devices to be added and/or removed without the hassle of reprogramming of a central microprocessor.

It will be understood that the circuits and other means supported by each block and combinations of blocks can be implemented by special purpose hardware, software or firmware operating on special or general-purpose data processors, or combinations thereof. It should also be noted that, in some alternative implementations, the operations noted in the blocks may occur out of the order noted in the figures. For example, two blocks shown in succession may, in fact, be executed substantially concurrently, or the blocks may sometimes be executed in the reverse order.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. A method of operating a networked device coupled to a uninterruptible power supply (UPS), comprising programming at least one networked device with priority information and to enter a reduced power state based on the priority information following receipt of a power interruption indication signal from the UPS indicating that power from a primary source of power has been interrupted.

2. The method of claim 1, further comprising:
receiving the power interruption indication signal at the at least one programmed networked device; and
entering the reduced power state at the at least one programmed networked device based on the priority information responsive to the received power interruption indication signal.

3. The method of claim 2, further comprising setting a timer at the at least one programmed networked device based on the priority information responsive to the received power interruption indication signal, wherein entering the reduced power state comprises entering the reduced power state at the at least one programmed networked device upon expiration of the timer.

4. The method of claim 3, further comprising sounding an alert signal at the at least one programmed networked device responsive to the received power interruption indication signal so as to provide notification that the at least one programmed networked device will enter a reduced power state.

5. The method of claim 2, further comprising:
receiving a power restoration indication signal from the UPS at the at least one programmed networked device indicating that power from the primary source of power has been restored; and
initiating a power up process at the at least one programmed networked device based on the priority information responsive to the power restoration indication signal.

6. The method of claim 5, further comprising setting a timer at the at least one programmed networked device based on the priority information responsive to the received power restoration indication signal, wherein initiating a power up process further comprises initiating a power up process at the at least one programmed networked device upon expiration of the timer.

7. The method of claim 5, further comprising sounding an alert signal at the at least one programmed networked device responsive to the received power restoration indication signal so as to provide notification that the at least one programmed networked device will be powered up.

8. A method of operating devices in a system, comprising:
pre-configuring a first device, having a first associated importance level and being coupled to a backup power source through a power distribution device, to enter a reduced power state at a first time following receipt of a power interruption indication signal;
pre-configuring a second device, having a second associated importance level, greater than the first importance level and being coupled to the backup power source through the power distribution device, to enter the reduced power state at a second time, greater than the first time, following receipt of the power interruption indication signal;
transmitting the power interruption indication signal from the power distribution device indicating that power from a primary source of power has been interrupted;
receiving the power interruption indication signal from the power distribution device at the first and second devices; and
entering the reduced power state at the first device at the first time and at the second device at the second time responsive to the received power interruption indication signal.

9. The method of claim 8, wherein entering a reduced power state is preceded by:
setting a first timer at the first device to the first time and a second timer at the second device to the second time responsive to the received power interruption indication signal, wherein entering the reduced power state at the first device comprises entering the reduced power state at the first device upon expiration of the first timer and wherein entering the reduced power state at the second device comprises entering the reduced power state at the second device upon expiration of the second timer.

10. The method of claim 8, wherein pre-configuring the first device comprises pre-configuring a first group of devices having the first importance level and wherein pre-configuring the second device comprises pre-configuring a second group of devices having the second importance level and wherein entering the reduced power state is preceded by:
setting a first timer at the first group of devices to the first time and a second timer at the second group of devices to the second time responsive to the received power interruption indication signal, wherein entering the reduced power state at the first group of devices comprises entering the reduced power state at the first group of devices upon expiration of the first timer and wherein entering the reduced power state at the second group of devices comprises entering the reduced power state at the second group of devices upon expiration of the second timer.

11. The method of claim 8, wherein entering the reduced power state is preceded by sounding an alert signal at the first and/or second devices responsive to the received power interruption indication signal so as to provide notification that power at the first and/or second devices will be reduced.

12. The method of claim 8, further comprising:
transmitting a power restoration indication signal to the first and/or second devices indicating that power from a primary source of power has been restored;
receiving the power restoration indication signal at the first and/or second devices; and
initiating a power up process at the first and/or second devices responsive to the received power restoration indication signal.

13. The method of claim 12, wherein initiating a power up process is preceded by:
setting a first timer at the first device to a third time and a second timer at the second device to a fourth time responsive to the received power restoration indication signal, wherein initiating the power up process at the first device comprises initiating the power up process at the first device upon expiration of the first timer and wherein initiating the power up process at the second device comprises initiating the power up process at the second device upon expiration of the second timer.

14. The method of claim 12, further comprising sounding an alert signal at the first device and/or the second device responsive to the received power restoration indication signal so as to provide notification that the first and/or second devices will be powered up.

15. A networked device coupled to a uninterruptible power supply (UPS), comprising:
a pre-configuration circuit configured to be programmed with priority information and to pre-configure the device to enter a reduced power state based on the priority information following receipt of a power interruption indication signal from the UPS indicating that power from a primary source of power has been interrupted.

16. The network device of claim 15, further comprising:
a receiver configured to receive the power interruption indication signal at the programmed networked device; and
a power module configured to enter the reduced power state at the programmed networked device based on the priority information responsive to the received power interruption indication signal.

17. The network device of claim 16, further comprising a timer circuit configured to set a timer at the programmed networked device based on the priority information responsive to the received power interruption indication signal, wherein the power module is further configured to enter the reduced power state at the programmed networked device upon expiration of the timer.

18. The network device of claim 17, further comprising an alert circuit configured to sound an alert signal at the programmed networked device responsive to the received power interruption indication signal so as to provide notification that the at least one programmed networked device will enter the reduced power state.

19. The network device of claim 17, wherein the receiver is further configured to receive a power restoration indication signal from the UPS at the at least one programmed networked device indicating that power from the primary source of power has been restored and wherein the power module is further configured to initiate a power up process at the programmed networked device based on the priority information responsive to the power restoration indication signal.

20. The network device of claim 19, further comprising a timer circuit configured to set a timer at the programmed networked device based on the priority information responsive to the received power restoration indication signal, wherein the power module is further configured to initiate a power up process at the programmed networked device upon expiration of the timer.

21. The network device of claim 19, further comprising an alert circuit configured to sound an alert signal at the programmed networked device responsive to the received power restoration indication signal so as to provide notification that the programmed networked device will be powered up.

22. A system for operating devices, comprising:
a first pre-configured device, having a first associated importance level and coupled to a backup power source, configured to enter a reduced power state at a first time following receipt of a power interruption indication signal;
a second pre-configured device, having a second associated importance level, greater than the first importance level, and coupled to the backup power source, configured to enter the reduced power state at a second time, greater than the first time, following receipt of the power interruption indication signal; and
a power distribution device configured to couple the first and second devices to the backup power source and transmit a power interruption indication signal from the power distribution device indicating that power from a primary source of power has been interrupted, wherein the first and second devices are configured to receive the power interruption indication signal from the power distribution device and enter the reduced power state at the first device at the first time and at the second device at the second time responsive to the received power interruption indication signal.

23. The system of claim 22, wherein the first device is configured to set a first timer at the first device to the first time responsive to the received power interruption indication signal and enter the reduced power state at the first device upon expiration of the first timer and wherein the second device is configured to set a second timer at the second device to the second time responsive to the received power interruption indication signal and enter the reduced power state at the second device upon expiration of the second timer.

24. The system of claim 22, wherein the first device comprises a first group of devices having the first importance level, wherein the second device comprises a second group of devices having the second importance level, wherein the first group of devices are configured to set a first timer at the first group of devices to the first time responsive to the power interruption indication signal and enter the reduced power state at the first group of devices upon expiration of the first timer and wherein the second group of devices are configured to set a second timer at the second group of devices to the second time responsive to the received power interruption indication signal and enter the reduced power state at the second group of devices upon expiration of the second timer.

25. The system of claim 22, wherein the first and second devices are further configured to sound an alert signal at the first and second devices responsive to the received power interruption indication signal so as to provide notification that power at the first and second devices will be reduced.

26. The system of claim 22, wherein the power distribution device is further configured to transmit a power restoration indication signal to the first and/or second devices indicating that power from a primary source of power has been restored, wherein the first and second devices are configured to receive the power restoration indication signal and initiate a power up process at the first and/or second devices responsive to the received power restoration indication signal.

27. The system of claim 26, wherein the first device is configured to set a first timer at the first device to a third time and initiate the power up process at the first device upon expiration of the first timer and wherein the second device is further configured to set a second timer at the second device to a fourth time responsive to the received power restoration indication signal and initiate the power up process at the second device upon expiration of the second timer.

28. The system of claim 26, wherein the first and second devices are further configured to sound an alert signal at the first device and the second device responsive to the received power restoration indication signal so as to provide notification that the first and second devices will be powered up.

29. A computer program product for operating a networked device coupled to a uninterruptible power supply (UPS), the computer program product comprising:
a computer readable storage medium having computer readable program code embodied in said medium, said computer readable program code comprising:
computer readable program code configured to program at least one networked device with priority information and to enter a reduced power state based on the priority information following receipt of a power interruption indication signal from the UPS indicating that power from a primary source of power has been interrupted.

30. The computer program product of claim 29, further comprising:
computer readable program code configured to receive the power interruption indication signal at the at least one programmed networked device; and
computer readable program code configured to enter the reduced power state at the at least one programmed networked device based on the priority information responsive to the received power interruption indication signal.

31. The computer program product of claim 30, further comprising computer readable program code configured to set a timer at the at least one programmed networked device based on the priority information responsive to the received power interruption indication signal, wherein the computer readable program code configured to enter the reduced power state comprises computer readable program code configured to enter the reduced power state at the at least one programmed networked device upon expiration of the timer.

32. The computer program product of claim 31, further comprising computer readable program code configured to sound an alert signal at the at least one programmed networked device responsive to the received power interruption indication signal so as to provide notification that the at least one programmed networked device will enter the reduced power state.

33. The computer program product of claim 31, further comprising:
computer readable program code configured to receive a power restoration indication signal from the UPS at the at least one programmed networked device indicating that power from the primary source of power has been restored; and
computer readable program code configured to initiate a power up process at the at least one programmed networked device based on the priority information responsive to the power restoration indication signal.

34. The computer program product of claim 33, further comprising computer readable program code configured to set a timer at the at least one programmed networked device based on the priority information responsive to the received power restoration indication signal, wherein the computer readable program code configured to initiate a power up process further comprises computer readable program code configured to initiate a power up process at the at least one programmed networked device upon expiration of the timer.

35. The computer program product of claim 33, further comprising computer readable program code configured to sound an alert signal at the at least one programmed networked device responsive to the received power restoration indication signal so as to provide notification that the at least one programmed networked device will be powered up.
